(19) United States
(12) Patent Application Publication
(10) Pub. No.: US 2025/0223745 A1
(43) Pub. Date: Jul. 10, 2025

(54) WASHING MACHINE

(71) Applicant: SAMSUNG ELECTRONICS CO., LTD., Suwon-si (KR)

(72) Inventors: Changnyeun KIM, Suwon-si (KR); Jeongyun LEE, Suwon-si (KR); Yeajin CHO, Suwon-si (KR); Hwangmook CHO, Suwon-si (KR)

(73) Assignee: SAMSUNG ELECTRONICS CO., LTD., Suwon-si (KR)

(21) Appl. No.: 19/022,380

(22) Filed: Jan. 15, 2025

Related U.S. Application Data
(63) Continuation of application No. PCT/KR2024/020463, filed on Dec. 17, 2024.

(30) Foreign Application Priority Data
Jan. 4, 2024 (KR) 10-2024-0001807

(51) Int. Cl. D06F 35/00; B08B 7/00; D06F 39/02; D06F 39/04; D06F 103/30; D06F 103/32

(52) U.S. Cl. CPC D06F 35/00; B08B 7/0021; D06F 39/02; D06F 39/04; D06F 2103/30; D06F 2103/32

(57) ABSTRACT

A washing machine may include: a washing tub having a first opening and a second opening; a pump; and a chiller; wherein a first flow path connects the second opening, the pump, the chiller, and the first opening so that pumping by the pump moves carbon dioxide from inside the washing tub through the second opening along the first flow path to pass through the pump, then along the first flow path to pass through the chiller so as to be cooled by the chiller, and then along the first flow path to pass through the first opening to be returned to the washing tub.

### CROSS-REFERENCE TO RELATED APPLICATIONS

This is a continuation application, under 35 U.S.C. § 111 (a), of International Application No. PCT/KR2024/020463, filed Dec. 17, 2024, which claims priority under 35 U.S.C. § 119 to Korean Patent Application No. 10-2024-0001807, filed Jan. 4, 2024, in the Korean Intellectual Property Office, the disclosures of which are incorporated herein in their entireties by reference.

### TECHNICAL FIELD

The disclosures relates to a washing machine.

### BACKGROUND ART

Generally, a washing machine is an appliance that wash laundry using water as a cleansing agent. In contrast, there is a dry cleaning machine that washes laundry using volatile organic compounds as a cleansing agent instead of water. Dry cleaning machines may use solvents, petroleum-based cleansing agent, etc.

Washing machines using water generate wastewater during the washing process, polluting the environment, and the solvent-based cleansing agents and petroleum-based cleansing agents used in dry cleaning machines may be harmful to the human body and pollute the environment.

Instead of the above described cleansing agents, carbon dioxide may be used as a cleansing agent. Carbon dioxide may, due to a lower viscosity than water, easily penetrate between fibers and remove contaminants. After washing, the carbon dioxide containing foreign substances may be vaporized such that the carbon dioxide and the foreign substances may be separated from each other, and the vaporized carbon dioxide may be reused.

Carbon dioxide, which is one of the common components of the atmosphere, does not pollute the environment, and since it is reused by vaporizing and liquefying liquid carbon dioxide, the emission is kept low, contributing to achievement of carbon neutrality.

### DISCLOSURE

### Technical Problem

One aspect of the disclosure provides a washing machine having a 2-tank structure including a washing tub and a distillation tank, without a separate carbon dioxide storage tank, that is capable of controlling the temperature and pressure inside the washing tub before a washing or rinsing operation is performed.

One aspect of the disclosure provides a washing machine having a 2-tank structure, capable of controlling the temperature and pressure not only in the washing tub but also in the distillation tank.

The technical objectives of the disclosure are not limited to the above, and other objectives may become apparent to those of ordinary skill in the art based on the following description.

### Technical Solution

A washing machine according to an embodiment may include: a washing tub having a first opening and a second opening; a pump configured to move liquid and gaseous carbon dioxide; and a chiller, wherein a first flow path may connect the second opening, the pump, the chiller, and the first opening so that pumping by the pump moves carbon dioxide from inside the washing tub through the second opening along the first flow path to pass through the pump, then along the first flow path to pass through the chiller so as to be cooled by the chiller, and then along the first flow path to pass through the first opening to be returned to the washing tub.

The washing machine may further include: a distillation tank, wherein a second flow path may connect the distillation tank, the pump, and the first opening so that pumping by the pump moves carbon dioxide from inside the distillation tank along the second flow path to pass through the pump, then along the second flow path through the first opening to the washing tub.

The washing machine may further include: a first valve configured to open and close the first flow path; a second valve configured to open and close the second flow path; and a controller configured to: control the first valve and the second valve to open the first flow path and close the second flow path so that pumping by the pump moves the carbon dioxide from inside the washing tub through the second opening along the first flow path at a first temperature and a first pressure to pass through the pump, then along the first flow path to pass through the chiller so as to be cooled by the chiller, and then along the first flow path to pass through the first opening to be returned to the washing tub at a second temperature lower than the first temperature and at a second pressure lower than the first pressure, and control the first valve and the second valve to open the second flow path and close the first flow path so that pumping by the pump moves the carbon dioxide from inside the distillation tank along the second flow path at a third temperature and a third pressure to pass through the pump, then along the second flow path through the first opening to the washing tub at a fourth temperature higher than the third temperature and a fourth pressure higher than the third pressure.

The washing machine may further include: a heater configured to heat the distillation tank, wherein a third flow path may connect the distillation tank, the chiller, and the first opening so that heating by the heater moves the carbon dioxide from inside the distillation tank along the third flow path to pass through the chiller so as to be cooled by the chiller, and then along the third flow path to pass through the first opening to the washing tub, and the third flow path may branch from the second flow path at a point on the second flow path and merge with the first flow path at a point on the first flow path.

The washing machine may further include: a supplementary tank, wherein the supplementary tank may connect to the second flow path at an upstream side of the pump so that pumping by the pump moves carbon dioxide from inside the supplementary tank along the second flow path through the pump, then along the second flow path to pass through the first opening to the washing tub.

A fourth flow path may connect the second opening, the pump, and the distillation tank so that pumping by the pump moves the carbon dioxide from inside the washing tub through the second opening along the fourth flow path to pass through the pump, then along the fourth flow path to the distillation tank, and the fourth flow path may branch from the first flow path at a downstream side of the pump.

A fifth flow path may connect the second opening, the pump, the chiller, and the distillation tank so that pumping by the pump moves the carbon dioxide from inside the washing tub through the second opening along the fifth flow path through the pump, then along the fifth flow path to pass through the chiller so as to be cooled by the chiller, and then along the fifth flow path to the distillation tank, and the fifth flow path may branch from the first flow path at a downstream side of the pump.

The washing machine may further include: a washing tub heat exchanger, wherein the fifth flow path may connect the second opening, the pump, the washing tub heat exchanger, and the distillation tank so that pumping by the pump moves the carbon dioxide from inside the washing tub through the second opening along the fifth flow path through the pump, then along the fifth flow path to pass through the washing tub heat exchanger so as to exchange heat with the carbon dioxide inside the washing tub, and then along the fifth flow path to the distillation tank.

The distillation tank may include a third opening and a fourth opening, and the fifth flow path may connect the downstream side of the pump to the third opening via the chiller.

The distillation tank may include a third opening and a fourth opening, and the fourth flow path may connect the downstream side of the pump to the fourth opening.

A sixth flow path may connect the third opening, the chiller, and the fourth opening so that cooling by the chiller moves the carbon dioxide from inside the distillation tank through the third opening along the sixth flow path at a fifth temperature and a fifth pressure to pass through the chiller so as to be cooled by the chiller, and then along the sixth flow path to pass through the fourth opening to be returned to the distillation tank at a sixth temperature lower than the fifth temperature and a sixth pressure lower than the fifth pressure.

The washing machine may further include a filter on an upstream side of the pump to prevent foreign substances larger than a predetermined size from flowing into the pump.

The heater may be adjacent to the distillation tank and may be configured to raise a temperature inside the distillation tank.

The washing machine may further include: a first temperature sensor configured to measure a temperature inside the washing tub, and a first pressure sensor configured to measure a pressure inside the washing tub.

The washing machine may further include: a second temperature sensor configured to measure the temperature inside the distillation tank, and a second pressure sensor configured to measure a pressure inside the distillation tank.

A method of controlling a washing machine including a washing tub, a distillation tank, a pump, and a chiller according to an embodiment includes: discharging air inside the washing tub, supplying carbon dioxide to the washing tub, controlling the temperature and pressure inside the washing tub, performing washing, discharging carbon dioxide in the washing tub to the distillation tank, supplying carbon dioxide to the washing tub, controlling the temperature and pressure inside the washing tub, performing rinsing, discharging carbon dioxide in the washing tub to the distillation tank, and depressurizing the inside of the washing tub.

### DESCRIPTION OF DRAWINGS

FIG. 1 is a conceptual diagram for describing the flow of carbon dioxide in a washing machine according to an embodiment.

FIG. 2 is a control block diagram illustrating a washing machine according to an embodiment.

FIG. 3 is a conceptual diagram for describing a process of supplying gaseous carbon dioxide to a washing tub in a washing machine according to an embodiment.

FIG. 4 is a conceptual diagram for describing a process of supplying liquid carbon dioxide to a washing tub in a washing machine according to an embodiment.

FIG. 5 is a conceptual diagram for describing a process of supplying carbon dioxide from a supplementary tank to a washing tub in a washing machine according to an embodiment.

FIG. 6 is a conceptual diagram for describing a process of lowering the temperature and pressure inside a washing tub in a washing machine according to an embodiment.

FIG. 7 is a conceptual diagram for describing a process of raising the temperature and pressure inside a washing tub in a washing machine according to an embodiment.

FIG. 8 is a conceptual diagram for describing a process of discharging carbon dioxide and foreign substances from a washing tub to a distillation tank in a washing machine according to an embodiment.

FIG. 9 is a conceptual diagram for describing a process of lowering the pressure inside a washing tub in a washing machine before opening the washing tub according to an embodiment.

FIG. 10 is a conceptual diagram for describing a process of lowering the temperature and pressure inside a distillation tank in a washing machine according to an embodiment.

FIG. 11 illustrates a method of controlling a washing machine according to an embodiment.

### MODES OF THE DISCLOSURE

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

The washing machine according to various embodiments may include a housing accommodating various components therein. The housing may be provided in the form of a box including a laundry inlet on one side thereof.

The washing machine may include a door for opening and closing the laundry inlet. The door may be rotatably mounted to the housing by a hinge. At least a portion of the door may be transparent or translucent to allow the inside of the housing to be seen.

The washing machine may include a drum provided to accommodate laundry.

The drum may perform each operation according to washing, rinsing, and/or spin-drying while rotating inside the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output through a screen, an indicator, or voice. The at least one output interface may include a Liquid Crystal Display (LCD) panel, a Light Emitting Diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between external devices, and support the performance of the communication through the established communication channel. According to one embodiment, the communication module may include a wireless communication module (e.g., a cellular communication module, a short-range wireless communication module, or a global navigation system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server on a mobile communication network.

According to one embodiment, the communication module may communicate with an external device such as a server, a user device and other home appliances through an access point (AP). The access point (AP) may connect a local area network (LAN), to which a washing machine or a user device is connected, to a wide area network (WAN) to which a server is connected. The washing machine or the user device may be connected to the server through the wide area network (WAN). The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, an embodiment according to the disclosure will be described in detail with reference to the accompanying drawings.

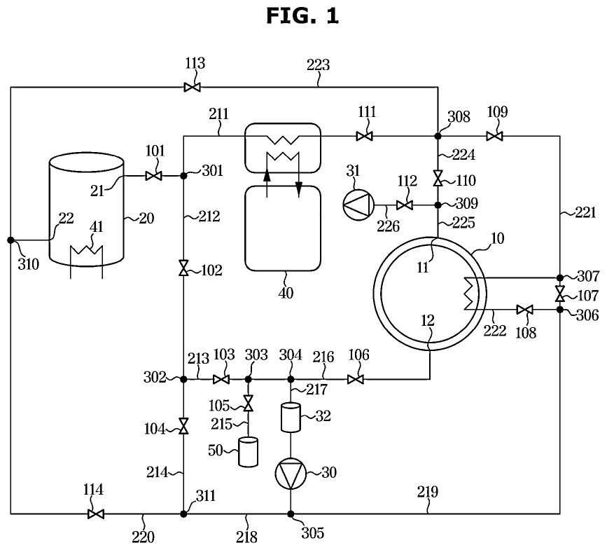

FIG. 1 is a conceptual diagram for describing the flow of carbon dioxide in a washing machine according to an embodiment.

Referring to FIG. 1, a washing machine according to an embodiment may include a washing tub 10 in which washing is performed using carbon dioxide, a distillation tank 20 provided to accommodate carbon dioxide and foreign substances discharged from the washing tub 10, a pump 30 provided to compress liquid carbon dioxide or gaseous carbon dioxide and move the compressed liquid carbon dioxide or gaseous carbon dioxide, and a chiller 40 disposed on a flow path through which carbon dioxide flows and configured to lower the temperature of the carbon dioxide. The washing machine may further include a supplementary tank 50 provided to supplement carbon dioxide lost in a process of carbon dioxide being recovered after washing.

The washing tub 10 may provide a space for washing laundry using liquid carbon dioxide as a cleansing agent. The washing tub 10 may store liquid carbon dioxide and gaseous carbon dioxide therein. The washing tub 10 may form a sealed space therein to store gaseous carbon dioxide at a high pressure of approximately 20 bar or higher. The washing tub 10 may be provided such that the internal pressure may be maintained at a predetermined pressure or higher. The washing tub 10 may be a type of pressure vessel.

A drum (not shown) may be rotatably disposed inside the washing tub 10. An openable door (not shown) may be provided in the washing tub 10 such that laundry may be inserted into the drum disposed inside the washing tub 10.

The washing tub 10 may include a first opening 11 formed in the washing tub 10 such that carbon dioxide outside the washing tub 10 may be introduced into the washing tub 10, and a second opening 12 formed in the washing tub 10 such that carbon dioxide inside the washing tub 10 may be discharged from the washing tub 10.

The above description does not exclude carbon dioxide discharge through the first opening 11. Similarly, the above description does not exclude carbon dioxide introduction through the second opening 12. Carbon dioxide may be discharged through the first opening 11, or carbon dioxide may be introduced through the second opening 12.

The first opening 11 may be formed at a higher position than the second opening 12. Gaseous carbon dioxide and/or liquid carbon dioxide may be introduced into the washing tub 10 through the first opening 11. The first opening 11 may be formed at a higher position than a full water level of the washing tub 10. The full water level may refer to the maximum water level of liquid carbon dioxide accommodated inside the washing tub 10.

In order that liquid carbon dioxide and foreign substances inside the washing tub 10 are discharged through the second opening 12 after a washing or rinsing cycle, the second opening 12 may be formed on the bottom surface of the washing tub 10 or at a position adjacent to the bottom surface.

In a process of inserting laundry into the drum inside the washing tub 10, air may be introduced into the washing tub 10. When air is introduced into the washing tub 10, moisture contained in the air may condense during a process of lowering the pressure inside the washing tub 10 after the washing. Condensation of moisture introduced between the laundry may result in damage to the laundry. To prevent such a constraint, the washing machine may further include a vacuum pump 31 provided to discharge air inside the washing tub 10.

The chiller 40 may be disposed on the flow path 200 through which carbon dioxide flows. The chiller 40 may be disposed adjacent to the flow path to exchange heat with the carbon dioxide flowing inside the flow path. The chiller 40 may lower the temperature of the carbon dioxide by exchanging heat with the carbon dioxide inside the flow path. The chiller 40 may liquefy the gaseous carbon dioxide inside the flow path. In other words, the gaseous carbon dioxide may be liquefied by passing through a portion of the flow path in which the chiller 40 is disposed.

The chiller 40 may liquefy the carbon dioxide discharged in a gaseous state from the distillation tank 20. Carbon dioxide discharged in a gaseous state from the distillation tank 20 may be liquefied by heat exchange with the chiller 40 and then supplied to the washing tub 10 in a liquid state. Conversely, carbon dioxide discharged in a gaseous state from the washing tub 10 may be liquefied by heat exchange with the chiller 40 and then returned to the distillation tank 20 in a liquid state. In addition, carbon dioxide discharged in a gaseous state from the distillation tank 20 may be liquefied by heat exchange with the chiller 40 and then returned to the distillation tank 20 in a liquid state. The specific flow of carbon dioxide will be described below.

The chiller 40 may include an evaporator of a heat pump. However, it is not limited thereto. The chiller 40 may include at least one of various types of cooling devices.

The distillation tank 20 may be provided to accommodate carbon dioxide and foreign substances discharged from the washing tub 10. The distillation tank 20 may accommodate liquid carbon dioxide discharged from the washing tub 10, foreign substances dissolved or not dissolved in the liquid carbon dioxide, and gaseous carbon dioxide therein.

The distillation tank 20 may include a third opening 21 and a fourth opening 22. Carbon dioxide inside the distillation tank 20 may be discharged through the third opening 21. In addition, carbon dioxide may be introduced into the distillation tank 20 through the third opening 21. Carbon dioxide may be introduced into the distillation tank 20 through the fourth opening 22. Although not shown in the drawing, carbon dioxide inside the distillation tank 20 may also be discharged through the fourth opening 22.

The third opening 21 may be formed at a position higher than the fourth opening 22. This is to facilitate the discharge of gaseous carbon dioxide inside the distillation tank 20 through the third opening 21, but the positions of the third opening 21 and the fourth opening 22 are not limited thereto. The third opening 21 and the fourth opening 22 may be formed at the same height, or the fourth opening 22 may be formed at a position higher than the third opening 21.

The washing machine according to the disclosure may not include a storage tank provided to store carbon dioxide. In the case of a washing machine including a storage tank, the washing tub may be supplied with carbon dioxide stored in the storage tank. Since the washing machine according to the disclosure does not include a storage tank, the washing tub 10 may be supplied with carbon dioxide contained inside the distillation tank 20. THE carbon dioxide supplied to the washing tub 10 may be recovered to the distillation tank 20 after the washing or rinsing cycle is completed.

In the process of carbon dioxide being recovered from the washing tub 10 to the distillation tank 20, loss of carbon dioxide may occur. To compensate for the loss, the washing machine may further include a supplementary tank 50.

The supplementary tank 50 may be provided to supplement carbon dioxide lost during a process of recovering carbon dioxide from the washing tub 10 to the distillation tank 20, a depressurization process for opening the washing tub, and other various processes. The supplementary tank 50 may be provided to store carbon dioxide therein. The supplementary tank 50 may supply carbon dioxide to the washing tub 10. Carbon dioxide inside the supplementary tank 50 may be supplied to the washing tub 10 via the pump 30. The supplementary tank 50 may be provided to be detachable from the washing machine. The supplementary tank 50 may be provided to be replaceable with another supplementary tank. Alternatively, the supplementary tank 50 may be provided to be detached from the washing machine, refilled with carbon dioxide inside, and then be reconnected to the washing machine.

In a process of supplying carbon dioxide from the distillation tank 20 to the washing tub 10, liquid carbon dioxide inside the distillation tank 20 may be vaporized. The foreign substances contained inside the distillation tank 20 may be separated from the carbon dioxide as the liquid carbon dioxide vaporizes. When the liquid carbon dioxide vaporizes, the foreign substances dissolved in the liquid carbon dioxide are separated from the liquid carbon dioxide. The foreign substances separated from the carbon dioxide and remaining inside the distillation tank 20 may be discharged to a foreign substance tank (not shown).

The foreign substance tank may be provided to store the foreign substances discharged from the distillation tank 20. The user may discharge the foreign substances stored in the foreign substance tank at appropriate intervals. The interval for emptying the foreign substance tank may vary depending on the capacity of the foreign substance tank and the amount of foreign substances included in the laundry.

The washing machine may include a heater 41 to vaporize the liquid carbon dioxide inside the distillation tank 20. The heater 41 may be disposed inside the distillation tank 20 and directly transfer heat to the carbon dioxide. Alternatively, the heater 41 may be disposed outside the distillation tank 20. The heater 41 may be disposed adjacent to the distillation tank 20 to increase the heat exchange efficiency with the carbon dioxide contained inside the distillation tank 20.

According to an embodiment, the washing machine may include a heat pump. In this case, an evaporator of the heat pump may be used as the chiller 40. A condenser of the heat pump may be used as the heater 41. Alternatively, various types of heat sources, such as an electric heater, a gas heater, and an oil heater, may be used as the heater of the washing machine according to an embodiment.

The washing machine may include a pump 30 configured to move liquid carbon dioxide or gaseous carbon dioxide. The pump 30 according to an embodiment may be configured to not only move liquid, but also compress gas and move the compressed gas. As described below, depending on the operation of the washing machine, liquid carbon dioxide may be introduced into the pump 30 or gaseous carbon dioxide may be introduced into the pump 30. In addition, liquid carbon dioxide and gaseous carbon dioxide may be introduced into the pump 30 in a mixed state.

Since the pump 30 according to an embodiment is configured to move a liquid, a gas, a mixture of liquid and gas, the pump 30 may move carbon dioxide introduced into the pump 30 regardless of the state of the carbon dioxide introduced into the pump 30. The carbon dioxide discharged from the pump 30 may be moved along the flow path 200 and then accommodated in the washing tub 10 or the distillation tank 20.

Since the washing machine according to the disclosure includes a pump 30 capable of moving a liquid, the arrangement of the washing tub 10 and the distillation tank 20 is not limited. In the case of a washing machine including a compressor provided to transport gas without a pump, the washing tub may be disposed higher than the distillation tank such that liquid carbon dioxide may be discharged from the washing tub to the distillation tank using the gravity. A washing machine with such a structure has a constraint that the washing tub needs to be disposed higher than the distillation tank. However, in the washing machine according to the disclosure in which the pump 30 is provided to move liquid carbon dioxide, the distillation tank 20 does not need to be disposed at a position lower than the washing tub 10. Accordingly, the distillation tank 20 and the washing tub 10 may be disposed at the same height, or alternatively, the distillation tank 20 may be positioned higher than the washing tub 10. In other words, the washing tub 10 and the distillation tank 20 may be arranged in various ways.

The washing machine may include a filter 32 provided to filter out foreign substances contained in carbon dioxide flowing into the pump 30. The filter 32 may be provided to filter out foreign substances having a relatively large volume. For example, the filter 32 may filter out objects accidentally included in laundry and/or foreign substances that are large enough to interfere with the operation of the pump 30 from flowing into the pump 30. Foreign substances having passed through the filter 32 without being filtered out by the filter 32 may be separated inside the distillation tank 20 and discharged into the foreign substance tank.

The filter 32 may be provided on the flow path 200 through which carbon dioxide flows. Since the filter 32 is configured to prevent foreign substances from flowing into the pump 30, the filter 32 may be provided upstream of the pump 30 on the flow path 200. In other words, the pump 30 may be provided downstream of the filter 32 on the flow path 200.

Referring to FIG. 1, the washing machine may include a flow path 200 through which carbon dioxide flows. The flow path 200 may be formed by various types of structures including pipes and ducts.

Carbon dioxide may move along the flow path 200. Gaseous carbon dioxide, liquid carbon dioxide, and a mixture of gaseous carbon dioxide and liquid carbon dioxide may move along the flow path 200. The flow path 200 may form a passage through which carbon dioxide moves. The flow path 200 may connect the washing tub 10, the distillation tank 20, and the pump 30 described above. The flow path 200 may connect the washing tub 10, the distillation tank 20, and the pump 30 through at least one passage.

The flow path 200 may be provided with a flow path connecting portion 300 in which a plurality of flow paths are merged into one flow path or one flow path is branched into a plurality of flow paths. The flow path 200 may be provided with a plurality of the flow path connecting portions 300.

The washing machine may include a valve 100 provided in the flow path 200. The valve 100 may be provided to open and close the flow path 200. The washing machine may include a plurality of valves 100. Each of the plurality of valves 100 may be controlled by a controller 60.

The valves may include first to fourteenth valves 101 to 114. The flow paths 200 may include first to eighth flow paths 201 to 208. The flow path connecting portion may include the first to eleventh flow path connecting portions 301 to 311. Specific descriptions of the valves, the flow paths, and the flow path connecting portions will be described below.

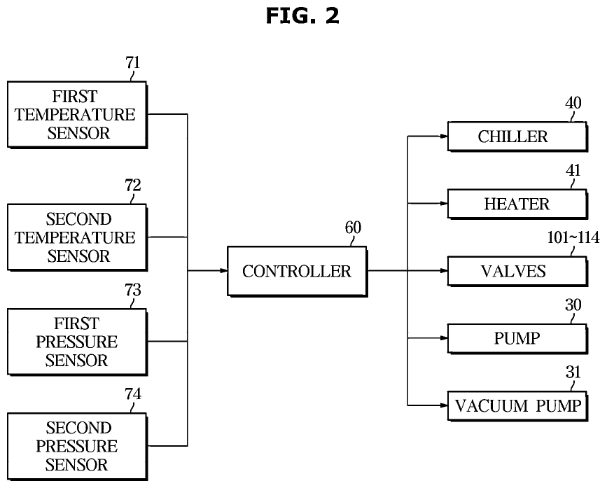

FIG. 2 is a control block diagram of a washing machine according to an embodiment.

Referring to FIG. 2, the washing machine may include a first temperature sensor 71 provided to measure the temperature inside the washing tub 10 and a second temperature sensor 72 provided to measure the temperature inside the distillation tank 20. In addition, the washing machine may include a first pressure sensor 73 provided to measure the pressure inside the washing tub 10 and a second pressure sensor 74 provided to measure the pressure inside the distillation tank 20.

The washing machine may include a controller 60 provided to control the first to fourteenth valves 101 to 114, the pump 30, and the vacuum pump 31.

The controller 60 may receive temperature data individually measured by the first temperature sensor 71 and the second temperature sensor 72. The controller 60 may control the first to fourteenth valves 101 to 114, the pump 30, and the vacuum pump 31 based on the temperature data transmitted from the first temperature sensor 71 and the second temperature sensor 72.

The controller 60 may receive pressure data individually measured by the first pressure sensor 73 and the second pressure sensor 74. The controller 60 may control the first to fourteenth valves 101 to 114, the pump 30, and the vacuum pump 31 based on the pressure data transmitted from the first pressure sensor 73 and the second pressure sensor 74.

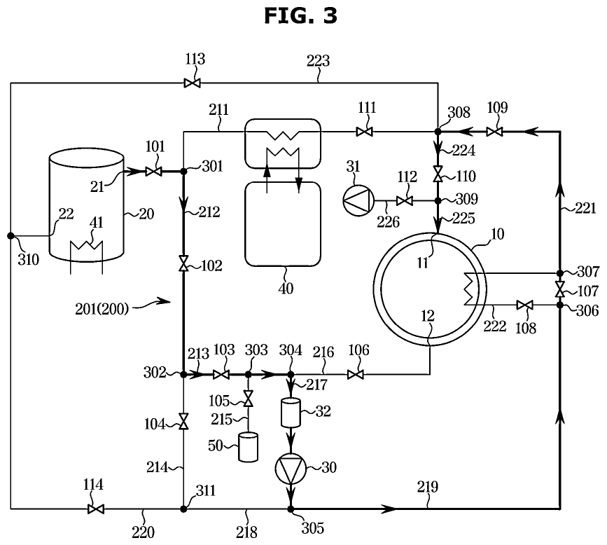

FIG. 3 is a conceptual diagram for describing a process of supplying gaseous carbon dioxide to a washing tub in a washing machine according to an embodiment.

Hereinafter, a process of supplying gaseous carbon dioxide to the washing tub 10 will be described with reference to FIG. 3.

As described above, the washing tub 10 may accommodate a drum (not shown) that is rotatably disposed inside the washing tub 10. Laundry may be insertable into the drum, and the drum may include a drum opening through which laundry may be inserted. The washing tub 10 may include a washing tub opening (not shown) formed with substantially the same size and shape as the drum opening to allow insertion of laundry into the drum, and a door (not shown) provided to open and close the washing tub opening. After opening the door of the washing tub 10, the user may insert laundry into the drum through the washing tub opening and the drum opening. When the insertion of laundry is completed, the user may close the door of the washing tub 10.

The controller 60 may, when laundry is inserted into the drum inside the washing tub 10 and the door is closed, operate the vacuum pump 31 to discharge air inside the washing tub 10. The controller 60 may open the twelfth valve 112 and operate the vacuum pump 31. The vacuum pump 31 may forcefully discharge the air inside the washing tub 10 to form a low-pressure state close to a vacuum inside the washing tub 10.

When the air inside the washing tub 10 is discharged as the vacuum pump 31 operates, carbon dioxide in the distillation tank 20 may be supplied to the washing tub 10. More specifically, gaseous carbon dioxide inside the distillation tank 20 may be supplied to the washing tub 10. Hereinafter, an operation of increasing the pressure inside the washing tub 10 by supplying the gaseous carbon dioxide to the washing tub 10, of which the internal pressure has been greatly reduced due to the operation of the vacuum pump 31, may be referred to as the pressurizing operation.

The washing machine may include a first flow path 201 that connects the distillation tank 20 and the washing tub 10. Carbon dioxide in the distillation tank 20 may move to the washing tub 10 along the first flow path 201. Carbon dioxide inside the distillation tank 20 may be supplied to the washing tub 10 through the filter 32 and the pump 30 along the first flow path 201.

In the pressurizing operation, the controller 60 may operate the heater 41. As the heater 41 operates, liquid carbon dioxide inside the distillation tank 20 may be vaporized into gaseous carbon dioxide. As vaporization occurs inside the distillation tank 20, gaseous carbon dioxide may be generated, and the gaseous carbon dioxide may be supplied to the washing tub 10 along the first flow path 201. The gaseous carbon dioxide from the distillation tank 20 introduced into the first flow path 201 may pass through the filter 32 and the pump 30 and then move to the washing tub 10. The pump 30 may provide kinetic energy to the carbon dioxide such that the carbon dioxide may move along the first flow path 201. Since the first flow path 201 is not provided with a chiller 40 and the carbon dioxide rises in temperature while passing through the pump 30, the carbon dioxide discharged in a gaseous state from the distillation tank 20 may be supplied to the washing tub 10 in a gaseous state without being liquefied. With such a configuration, the pressure inside the washing tub 10 may increase.

The first flow path 201 may be provided with a first valve 101, a second valve 102, a third valve 103, a seventh valve 107, a ninth valve 109, and a tenth valve 110. However, the number and arrangement of valves provided in the first flow path 201 may be modified within the scope that does not change the concept of the disclosure.

The first flow path 201 may be provided with a first flow path connecting portion 301, a second flow path connecting portion 302, a third flow path connecting portion 303, a fourth flow path connecting portion 304, a fifth flow path connecting portion 305, a sixth flow path connecting portion 306, a seventh flow path connecting portion 307, an eighth flow path connecting portion 308, and a ninth flow path connecting portion 309. However, the number and arrangement of flow path connecting portions provided in the first flow path 201 may be modified within the scope that does not change the concept of the disclosure.

In the pressurizing operation, the controller 60 may open the first valve 101, the second valve 102, the third valve 103, the seventh valve 107, the ninth valve 109, and the tenth valve 110. The controller 60 may close the eleventh valve 111, the fourth valve 104, the fifth valve 105, the sixth valve 106, the eighth valve 108, the twelfth valve 112, the thirteenth valve 113, and the fourteenth valve 114. The controller 60 may operate the pump 30.

When the first valve 101 is opened, carbon dioxide discharged through the third opening 21 of the distillation tank 20 may pass through the first valve 101 and move to the first flow path connecting portion 301. At the first flow path connecting portion 301, the flow path 200 may branch into a first branch flow path 211 in which the eleventh valve 111 is disposed, and a second branch flow path 212 in which the second valve 102 is disposed.

Since the second valve 102 is opened and the eleventh valve 111 is closed, carbon dioxide may move along the second branch flow path 212. A second flow path connecting portion 302 may be provided at the end of the second branch flow path 212. At the second flow path connecting portion 302, the flow path 200 may branch into a third branch flow path 213 in which the third valve 103 is disposed, and a fourth branch flow path 214 in which the fourth valve 104 is disposed.

Since the third valve 103 is opened and the fourth valve 104 is closed, carbon dioxide may move along the third branch flow path 213. The third branch flow path 213 may be provided with a third flow path connecting portion 303 and a fourth flow path connecting portion 304. At the third flow path connecting portion 303, the flow path 200 may branch into a fifth branch flow path 215 in which the fifth valve 105 is disposed. At the fourth flow path connecting portion 304, the flow path 200 may branch into a sixth branch flow path 216 in which the sixth valve 106 is disposed, and a seventh branch flow path 217 in which the filter 32 and the pump 30 are disposed.

Since the fifth valve 105 and the sixth valve 106 are closed, carbon dioxide may flow along the third branch flow path 213, pass through the third flow path connecting portion 303 and the fourth flow path connecting portion 304, entering the pump 30 via the filter 32. Carbon dioxide discharged by the pump 30 may move to the fifth flow path connecting portion 305. At the fifth flow path connecting portion 305, the flow path 200 may branch into an eighth branch flow path 218 in which the eleventh flow path connecting portion 311 is provided, and a ninth branch flow path 219 in which the sixth flow path connecting portion 306 is provided.

At the eleventh flow path connecting portion 311, the flow path 200 may branch into a fourth branch flow path 214 in which the fourth valve 104 is disposed, and a tenth branch flow path in which the fourteenth valve 114 is disposed. At the sixth flow path connecting portion 306, the flow path 200 may branch into an eleventh branch flow path 221 in which the seventh valve 107 and the ninth valve 109 are disposed, and a twelfth branch flow path 222 in which the eighth valve 108 is disposed and which passes through the washing tub 10. The eleventh branch flow path 221 and the twelfth branch flow path 222 may be merged at the seventh flow path connecting portion 307.

Since the fourteenth valve 114, the fourth valve 104, and the eighth valve 108 are closed, and the seventh valve 107 and the ninth valve 109 are opened, carbon dioxide discharged from the pump 30 may pass through the fifth flow path connecting portion 305, the sixth flow path connecting portion 306 and the seventh flow path connecting portion 307 and then move to the eighth flow path connecting portion 308. At the eighth flow path connecting portion 308, the flow path 200 may branch into the first branch flow path 211 in which the eleventh valve 111 and the chiller 40 are disposed, a thirteenth branch flow path 223 in which the thirteenth valve 113 is disposed, and a fourteenth branch flow path 224 in which the tenth valve 110 is disposed. The fourteenth branch flow path 224 may be provided with the ninth flow path connecting portion 309. At the ninth flow path connecting portion 309, the flow path 200 may branch into a fifteenth branch flow path 225 connected to the first opening 11 of the washing tub 10, and a sixteenth branch flow path 226 in which the twelfth valve 112 and the vacuum pump 31 are disposed.

Since the eleventh valve 111, the twelfth valve 112, and the thirteenth valve 113 are closed and the tenth valve 110 is opened, carbon dioxide may pass through the ninth branch flow path 309 and then move into the washing tub 10 through the first opening 11 of the washing tub 10.

Through the above-described paths, carbon dioxide in the distillation tank 20 may be supplied to the washing tub 10 in a gaseous state by passing through the filter 32 and the pump 30. As the gaseous carbon dioxide is supplied to the washing tub 10, the pressure inside the washing tub 10 may increase.

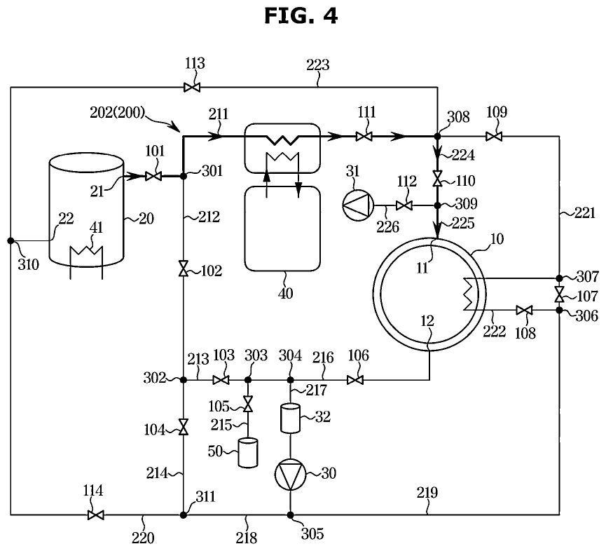

FIG. 4 is a conceptual diagram for describing a process of supplying liquid carbon dioxide to a washing tub in a washing machine according to an embodiment.

Hereinafter, a process of supplying liquid carbon dioxide to the washing tub 10 will be described with reference to FIG. 4.

When the pressure inside the washing tub 10 reaches a set value or higher as a result of the above-described pressurizing operation, the washing machine may supply liquid carbon dioxide to the washing tub 10. This may be referred to as a carbon dioxide supply operation or a liquid carbon dioxide supply operation.

In the carbon dioxide supply operation, the controller 60 may operate the heater 41. As the heater 41 operates, the liquid carbon dioxide inside the distillation tank 20 may be vaporized into gaseous carbon dioxide. The controller 60 may operate the chiller 40. As the chiller 40 operates, gaseous carbon dioxide passing through the first branch flow path 211 may be liquefied.

The controller 60 may open the first valve 101, the eleventh valve 111, and the tenth valve 110. The controller 60 may close the second valve 102, the thirteenth valve 113, the ninth valve 109, and the twelfth valve 112.

When the first valve 101 is opened, carbon dioxide discharged through the third opening 21 of the distillation tank 20 may pass through the first valve 101 and move to the first branch flow path connecting portion 301. As described above, at the first branch flow path connecting portion 301, the flow path 200 may branch into the first branch flow path 211 and the second branch flow path 212.

Since the second valve 102 is closed and the eleventh valve 111 is opened, the carbon dioxide may move along the first branch flow path 211, pass through the chiller 40 and then move to the eighth flow path connecting portion 308. As the carbon dioxide passes through a region of the flow path 200 in which in which the chiller 40 is disposed, the gaseous carbon dioxide inside the flow path 200 may be liquefied.

As described above, at the eighth flow path connecting portion 308, the flow path 200 may branch into the thirteenth branch flow path 223 in which the thirteenth valve 113 is disposed, the fourteenth branch flow path 224 in which the tenth valve 110 is disposed, and the eleventh branch flow path 221 in which the ninth valve 109 is disposed.

Since the thirteenth valve 113 and the ninth valve 109 are closed, and the tenth valve 110 is opened, the carbon dioxide may move along the fourteenth branch flow path 224 to the ninth flow path connecting portion 309.

At the ninth flow path connecting portion 309, the flow path 200 may branch into the sixteenth flow path 226 in which the twelfth valve 112 and the vacuum pump 31 are disposed, and the fifteenth flow path 225 connected to the first opening 11 of the washing tub 10. Since the twelfth valve 112 is closed, the carbon dioxide may move along the fifteenth flow path 225 into the washing tub 10 through the first opening 11 of the washing tub 10.

Through the above-described passage, the carbon dioxide in the distillation tank 20 may be supplied to the washing tub 10 in a liquid state via the chiller 40. After the liquid carbon dioxide is supplied to the washing tub 10, the drum inside the washing tub 10 may be rotated to perform the washing cycle.

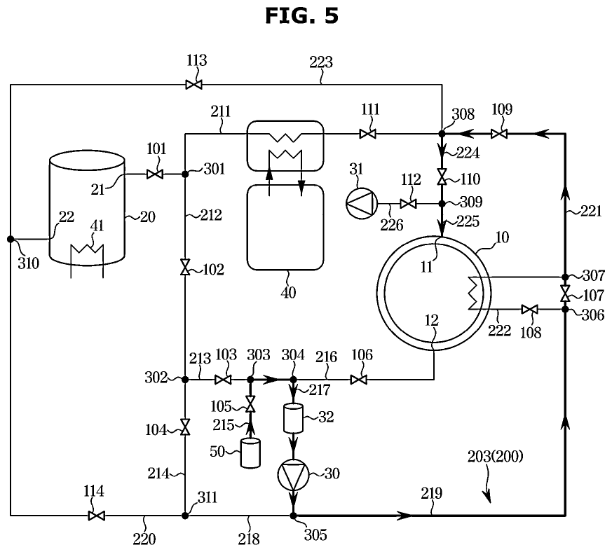

FIG. 5 is a conceptual diagram for describing a process of supplying carbon dioxide from a supplementary tank to a washing tub in a washing machine according to an embodiment.

Hereinafter, a process of supplying carbon dioxide from the supplementary tank 50 to the washing tub 10 will be described with reference to FIG. 5.

As described below, carbon dioxide may be lost during the processes such as recovering carbon dioxide from the washing tub 10 to the distillation tank 20, depressurizing the inside of the washing tub 10 after washing is completed, or discharging foreign substances inside the distillation tank 20 to a foreign substance tank. To supplement carbon dioxide, the supplementary tank 50 may be provided as described above.

According to an embodiment, carbon dioxide from the supplementary tank 50 may be supplied to the washing tub 10. Although not shown in the drawing, carbon dioxide from the supplementary tank 50 may also be supplied to the distillation tank 20.

When supplying carbon dioxide from the supplementary tank 50 to the washing tub 10, the controller 60 may open the fifth valve 105, the seventh valve 107, the ninth valve 109, and the tenth valve 110. The controller 60 may close the third valve 103, the sixth valve 106, the fourth valve 104, the fourteenth valve 114, the eighth valve 108, the thirteenth valve 113, the eleventh valve 111, and the twelfth valve 112. The controller 60 may operate the pump 30.

When the fifth valve 105 is opened, the carbon dioxide in the supplementary tank 50 may move along the fifth branch flow path 215 to the third flow path connecting portion 303. Since the third valve 103 and the sixth valve 106 are closed at the third flow path connecting portion 303, carbon dioxide may pass through the filter 32 and flow into the pump 30.

The carbon dioxide discharged from the pump 30 may move to the fifth flow path connecting portion 305. Since the fourth valve 104 and the fourteenth valve 114 are closed and the seventh valve 107 is opened at the fifth flow path connecting portion 305, carbon dioxide may move along the ninth branch flow path 219 to the sixth flow path connecting portion 306.

Since the eighth valve 108 is closed and the seventh valve 107 and the ninth valve 109 are opened, carbon dioxide may pass through the sixth flow path connecting portion 306 and flow into the eighth flow path connecting portion 308.

Since the eleventh valve 111 and the thirteenth valve 113 are closed and the tenth valve 110 is opened at the eighth flow path connecting portion 308, carbon dioxide may move to the ninth flow path connecting portion 309. Since the twelfth valve 112 is closed at the ninth flow path connecting portion 309, carbon dioxide may move along the fifteenth branch flow path 225 and enter the washing tub 10 through the first opening 11 of the washing tub 10.

Through the above-described passage, carbon dioxide from the supplementary tank 50 may be supplied to the washing tub 10 after passing through the filter 32 and the pump 30. By replenishing carbon dioxide from the replenishment tank 50, the amount of carbon dioxide required for the operation of the washing machine may be maintained.

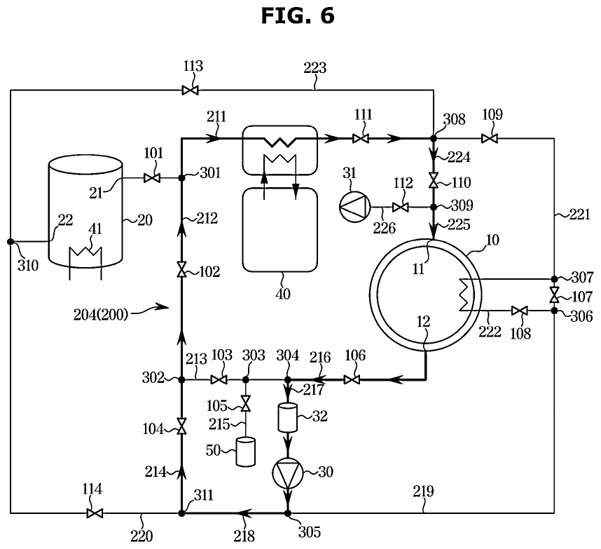

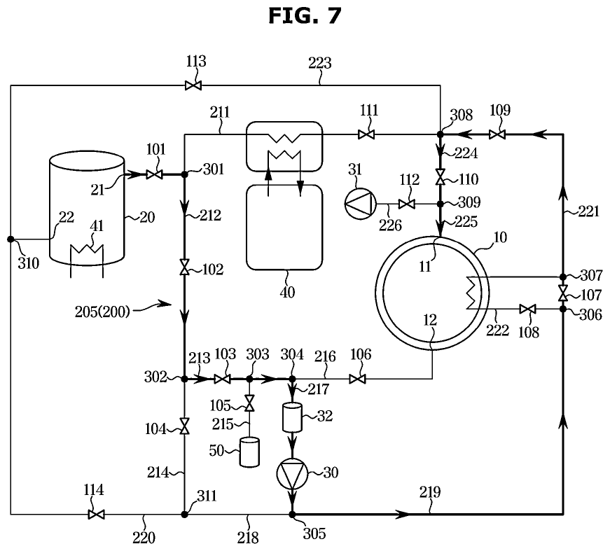

FIG. 6 is a conceptual diagram for describing a process of lowering the temperature and pressure inside a washing tub in a washing machine according to an embodiment. FIG. 7 is a conceptual diagram for describing a process of raising the temperature and pressure inside a washing tub in a washing machine according to an embodiment.

Hereinafter, a process of lowering the temperature and pressure inside the washing tub 10 and a process of raising the temperature and pressure inside the washing tub 10 will be described with reference to FIGS. 6 and 7.

When gas and liquid carbon dioxide are supplied into the washing tub 10 through the processes described in FIGS. 3 to 5, the drum may be rotated to perform washing. Before performing washing, the temperature and pressure inside the washing tub 10 need to be adjusted to a set value or within a set range.

When the temperature inside the washing tub 10 is excessively low, moisture in the air remaining inside the washing tub 10 may condense. When moisture that has penetrated the laundry condenses, damage to the laundry may occur. Conversely, when the temperature inside the washing tub 10 is excessively high, liquid carbon dioxide inside the washing tub 10 may vaporize. This may cause a shortage of liquid carbon dioxide inside the washing tub 10 or an excessive increase in pressure inside the washing tub 10.

In order to control the temperature and pressure inside the washing tub 10, the washing machine may include a first temperature sensor 71 provided to measure the temperature inside the washing tub 10 and a first pressure sensor 73 provided to measure the pressure inside the washing tub 10. In addition, the washing machine may include a second temperature sensor 72 provided to measure the temperature inside the distillation tank 20 and a second pressure sensor 74 provided to measure the pressure inside the distillation tank 20.

Before performing washing or rinsing, the controller 60 may lower the temperature inside the washing tub 10 through a process described below based on temperature data received from the first temperature sensor 71. The controller 60 may lower the pressure inside the washing tub 10 through a process described below based on pressure data received from the first pressure sensor 73.

Referring to FIG. 6, in order to lower the temperature and pressure inside the washing tub 10, the controller 60 may open the sixth valve 106, the fourth valve 104, the second valve 102, the eleventh valve 111, and the tenth valve 110. The controller 60 may close the third valve 103, the fifth valve 105, the seventh valve 107, the eighth valve 108, the fourteenth valve 114, the first valve 101, the thirteenth valve 113, the ninth valve 109, and the twelfth valve 112. The controller 60 may operate the chiller 40 and the pump 30.

When the second opening 12 of the washing tub 10 is opened, the carbon dioxide in the washing tub 10 may exit through the second opening 12 and move along the sixth branch flow path 216, in which the sixth valve 106 is disposed, to the fourth flow path connecting portion 304.

At the fourth flow path connecting portion 304, in which the third valve 103 and the fifth valve 105 are closed, the carbon dioxide may pass through the filter 32 and the pump 30 and move to the fifth flow path connecting portion 305. At the fifth flow path connecting portion 305, the flow path 200 may branch into the ninth flow path 219 and the eighth flow path 218.

The seventh valve 107 provided in the ninth branch flow path 219, the eighth valve 108 provided in the twelfth branch flow path 222, and the fourteenth valve 114 provided in the tenth branch flow path 220 are closed, and the fourth valve 104 provided in the fourth branch flow path 214 is opened, and thus carbon dioxide may move from the fifth flow path connecting portion 305 to the eleventh flow path connecting portion 311 along the eighth branch flow path 218, and then move to the second flow path connecting portion 302 along the fourth branch flow path 214.

At the second flow path connecting portion 302, in which the third valve 103 is closed and the second valve 102 is opened, carbon dioxide may move to the first flow path connecting portion 301 along the second branch flow path 212. At the first flow path connecting portion 301, in which the first valve 101 is closed and the eleventh valve 111 is opened, carbon dioxide may move along the first branch flow path 211, pass through the chiller 40 and reach the eighth flow path connecting portion 308.

At the eighth flow path connecting portion 308, in which the thirteenth valve 113 and the ninth valve 109 are closed and the tenth valve 110 is opened, the carbon dioxide may move along the fourteenth branch flow path 224 to the ninth flow path connecting portion 309.

At the ninth flow path connecting portion 309, in which the twelfth valve 112 is closed, the carbon dioxide may move along the fifteenth branch flow path 225 and enter the washing tub 10 through the first opening 11 of the washing tub 10.

Through the above-described passage, the carbon dioxide discharged from the washing tub 10 may pass through the filter 32 and the pump 30, exchange heat with the chiller 40, and then reenter the washing tub 10. Since the carbon dioxide cooled or liquefied by heat-exchange with the chiller 40 is introduced into the washing tub 10, the temperature inside the washing tub 10 may be lowered and the pressure inside the washing tub 10 may be lowered.

The controller 60 may continue or stop the above processes based on the temperature data and pressure data transmitted through the first temperature sensor 71 and the first pressure sensor 73.

Before performing washing or rinsing, the controller 60 may increase the temperature inside the washing tub 10 through a process described below based on temperature data transmitted from the first temperature sensor 71. The controller 60 may increase the pressure inside the washing tub 10 through a process described below based on pressure data transmitted from the first pressure sensor 73.

Referring to FIG. 7, in order to increase the temperature and pressure inside the washing tub 10, the controller 60 may open the first valve 101, the second valve 102, the third valve 103, the seventh valve 107, the ninth valve 109, and the tenth valve 110. The controller 60 may close the eleventh valve 111, the fourth valve 104, the fifth valve 105, the sixth valve 106, the fourteenth valve 114, the eighth valve 108, the thirteenth valve 113, and the twelfth valve 112. The controller 60 may operate the pump 30. The controller 60 may operate the heater 41.

When the third opening 21 of the distillation tank 20 and the first valve 101 are opened, the carbon dioxide in the distillation tank 20 may pass through the third opening 21 and move to the first flow path connecting portion 301.

At the first flow path connecting portion 301, in which the eleventh valve 111 is closed and the second valve 102 is opened, the carbon dioxide may move along the second branch flow path 212 and reach the second flow path connecting portion 302. At the second flow path connecting portion 302, in which the fourth valve 104, the fifth valve 105, and the sixth valve 106 are closed, the carbon dioxide may pass through the third flow path connecting portion 303 and the fourth flow path connecting portion 304 and enter the filter 32 and the pump 30.

Carbon dioxide discharged from the pump 30 may, with the fourth valve 104 and the fourteenth valve 114 being closed, move to the sixth flow path connecting portion 306 along the ninth branch flow path 219. At the sixth flow path connecting portion 306, in which the eighth valve 108 is closed and the seventh valve 107 and the ninth valve 109 are opened, carbon dioxide may move to the eighth flow path connecting portion 308 through the seventh flow path connecting portion 307.

At the eighth flow path connecting portion 308, in which the thirteenth valve 113 and the eleventh valve 111 are closed and the tenth valve 110 is opened, carbon dioxide may move to the ninth flow path connecting portion 309 along the fourteenth branch flow path 224.

Since the twelfth valve 112 is closed at the ninth flow path connecting portion 309, carbon dioxide may move along the fifteenth flow path 225 and enter the washing tub 10 through the first opening 11 of the washing tub 10.

Through the above-described passage, carbon dioxide discharged from the distillation tank 20 may be supplied to the washing tub 10 after passing through the filter 32 and the pump 30. When the carbon dioxide having passed through the pump 30 is continuously supplied into the washing tub 10 while the second opening 12 of the washing tub 10 is closed, the pressure inside the washing tub 10 gradually increases and the temperature inside the washing tub 10 may also increase. In other words, as carbon dioxide from the distillation tank 20 is supplied to the washing tub 10, the pressure and temperature inside the washing tub 10 may increase.

The controller 60 may continue or stop the above processes based on the temperature data and pressure data received through the first temperature sensor 71 and the first pressure sensor 73.

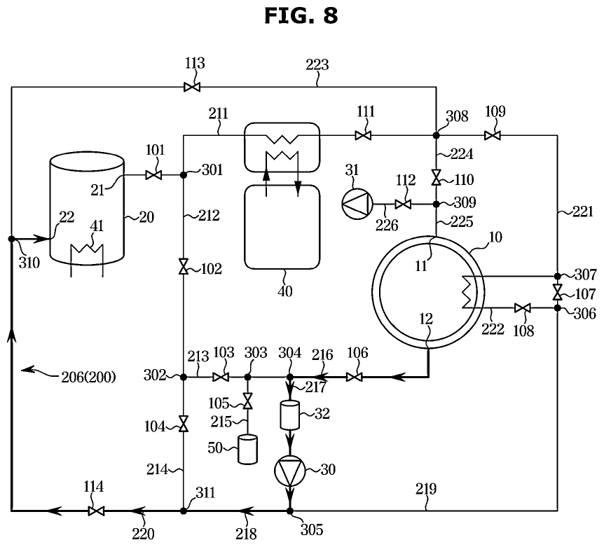

FIG. 8 is a conceptual diagram for describing a process of discharging carbon dioxide and foreign substances from a washing tub to a distillation tank in a washing machine according to an embodiment.

Hereinafter, referring to FIG. 8, a process of discharging carbon dioxide and foreign substances inside the washing tub 10 into the distillation tank 20 after washing or rinsing is completed will be described.

As described above with reference to FIGS. 6 and 7, the washing machine may adjust the temperature and pressure inside the washing tub 10 before performing a washing or rinsing cycle. After the temperature and pressure inside the washing tub 10 are adjusted, the drum is rotated to perform the washing cycle or the rinsing cycle. The washing cycle and the rinsing cycle differ in the order of the washing process, and may differ in the rotation speed of the drum and the duration of each cycle.

After the washing or rinsing cycle is completed, carbon dioxide and foreign substances inside the washing tub 10 may be discharged to the distillation tank 20.

Referring to FIG. 8, in order to discharge carbon dioxide and foreign substances inside the washing tub 10 to the distillation tank 20, the controller 60 may open the sixth valve 106 and the twelfth valve 112. The controller 60 may close the third valve 103, the fifth valve 105, the seventh valve 107, the eighth valve 108, and the fourth valve 104. The controller 60 may operate the pump 30.

When the second opening 12 of the washing tub 10 is opened and the sixth valve 106 is opened, carbon dioxide and foreign substances inside the washing tub 10 may move along the sixth branch flow path 216 to the fourth flow path connecting portion 304.

At the fourth flow path connecting portion 304, in which the third valve 103 and the fifth valve 105 are closed, carbon dioxide and foreign substances may pass through the filter 32 and enter the pump 30. As the carbon dioxide and foreign substances pass through the filter 32, some of the foreign substances may be removed by the filter 32.

The carbon dioxide and foreign substances discharged from the pump 30 may move to the fifth flow path connecting portion 305. At the fifth flow path connecting portion 305, in which the seventh valve 107, the eighth valve 108, and the fourth valve 104 are closed, and the fourteenth valve 114 is opened, carbon dioxide and foreign substances may move along the eighth branch flow path 218 to the eleventh flow path connecting portion 311, and then move along the tenth branch flow path 220 to the tenth flow path connecting portion 310.

At the tenth connecting portion 310, in which the thirteenth valve 113 is closed, carbon dioxide and foreign substances may flow into the distillation tank 20 through the fourth opening 22 of the distillation tank 20.

After the washing or rinsing is completed, the liquid carbon dioxide used for washing and rinsing remains inside the washing tub 10, and thus the liquid carbon dioxide may be discharged into the distillation tank 20 through the above described process. The liquid carbon dioxide in the washing tub 10 may be recovered to the distillation tank 20. Recovering liquid carbon dioxide does not exclude a recovery of gaseous carbon dioxide. Through the above process, not only the liquid carbon dioxide inside the washing tub 10 but also the gaseous carbon dioxide may be recovered into the distillation tank 20.

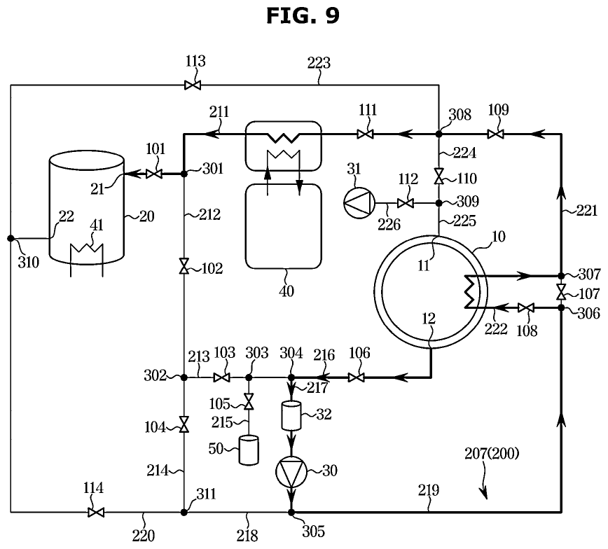

FIG. 9 is a conceptual diagram for describing a process of lowering the pressure inside a washing tub before opening a washing tub in a washing machine according to an embodiment.

Hereinafter, with reference to FIG. 9, a process of lowering the pressure inside the washing tub 10 to a level similar to the atmospheric pressure before the washing tub 10 is opened after the completion of the washing is described.

After the operation of pressurization described above with reference to FIG. 3, the operation of supplying gaseous carbon dioxide to the washing tub described with reference to FIG. 4, the operation of supplying liquid carbon dioxide to the washing tub described with reference to FIG. 5, and the operation of controlling the temperature and pressure inside the washing tub described with reference to FIGS. 6 and 7, the washing cycle may be performed. After the washing cycle is completed, the carbon dioxide and foreign substances in the washing tub may be discharged to the distillation tank as described with reference to FIG. 8.

After the above process, liquid carbon dioxide may be supplied back to the washing tub from the distillation tank, and a rinsing cycle may be performed. When the rinsing cycle is completed, the carbon dioxide and foreign substances in the washing tub may be discharged to the distillation tank. The above washing and rinsing processes may be repeated several times depending on the settings of the washing machine.

When the washing of the washing machine is completed, the laundry loaded inside the washing tub 10 needs to be taken out. Even when the washing is completed, the pressure inside the washing tub 10 is still higher than the atmospheric pressure, so there is a need to lower the pressure to a level equal to or similar to the atmospheric pressure before opening the door of the washing tub 10. The operation of lowering the pressure inside the washing tub 10 to open the door of the washing tub 10 may be referred to as a depressurizing operation.

Referring to FIG. 9, in the depressurizing operation, the controller 60 may open the sixth valve 106, the eighth valve 108, the ninth valve 109, the eleventh valve 111, and the first valve 101. The controller 60 may close the third valve 103, the fifth valve 105, the fourth valve 104, the fourteenth valve 114, the seventh valve 107, the thirteenth valve 113, the tenth valve 110, and the second valve 102. The controller 60 may operate the chiller 40. The controller 60 may operate the pump 30.

When the second opening 12 of the washing tub 10 is opened and the sixth valve 106 is opened, carbon dioxide inside the washing tub 10 may move along the sixth branch flow path 216 to the fourth flow path connecting portion 304.

Since the third valve 103 and the fifth valve 105 are closed, carbon dioxide at the fourth flow path connecting portion 304 may flow into the pump 30 through the filter 32. Carbon dioxide discharged from the pump 30 may move to the fifth flow path connecting portion 305.

At the fifth flow path connecting portion 305, in which the fourth valve 104 and the fourteenth valve 114 are closed, carbon dioxide may move to the sixth flow path connecting portion 306 along the ninth branch flow path 219. At the sixth flow path connecting portion 306, in which the seventh valve 107 is closed and the eighth valve 108 is opened, carbon dioxide may move to the seventh flow path connecting portion 307 along the twelfth branch flow path 222.

The twelfth branch flow path 222 may pass through the inside of the washing tub 10 or the outside of the washing tub 10 adjacent to the washing tub 10. By passing through the inside of the washing tub 10 or the outside of the washing tub 10 adjacent to the washing tub 10, the twelfth branch flow path 222, in which carbon dioxide having risen in temperature by passing through the pump 30 flows, may exchange heat with the carbon dioxide inside the washing tub 10. Hereinafter, the twelfth branch flow path 222 may be referred to as a washing tub heat exchanger 222. The carbon dioxide inside the washing tub 10 may rise in temperature by the heat exchange, and the liquid carbon dioxide may be vaporized.

At the seventh flow path connecting portion part 307, in which the ninth valve 109 is opened, the carbon dioxide may move to the eighth flow path connecting portion part 308. At the eighth flow path connecting portion 308, in which the ninth valve 109 and the thirteenth valve 113 are closed and the eleventh valve 111 is opened, carbon dioxide may move along the first branch flow path 211, pass through the chiller 40, and reach the first flow path connecting portion 301. Since the chiller 40 is provided in the first branch flow path 211 connecting the eighth flow path connecting portion 308 and the first flow path connecting portion 301, carbon dioxide may exchange heat with the chiller 40. By exchanging heat with the chiller 40, carbon dioxide passing through the first branch flow path 211 decreases in temperature, and the gaseous carbon dioxide may be liquefied.

At the first flow path connecting portion 301, in which the second valve 102 is closed and the first valve 101 is opened, carbon dioxide may move into the distillation tank 20 through the third opening 21 of the distillation tank 20. By passing through the chiller 40 provided in the first branch flow path 211, the carbon dioxide may be introduced into the distillation tank 20 in a liquid state.

Through the above-described path, carbon dioxide from the washing tub 10 may be recovered to the distillation tank 20 after passing through the filter 32, the pump 30, and the chiller 40. The carbon dioxide, which has risen in temperature by passing through the pump 30, may raise the temperature of the carbon dioxide inside the washing tub 10 or vaporize the carbon dioxide inside the washing tub 10 by passing through the washing tub 10.

As described with reference to FIG. 8, the liquid carbon dioxide inside the washing tub 10 may be first recovered to the distillation tank 20, and then the gaseous carbon dioxide remaining in the washing tub 10 may be recovered. Therefore, the gaseous carbon dioxide inside the washing tub 10 may be recovered to the distillation tank 20 through the process described above with reference to FIG. 9. However, even in this case, not only the gaseous carbon dioxide but also the liquid carbon dioxide remaining inside the washing tub 10 may be recovered to the distillation tank 20.

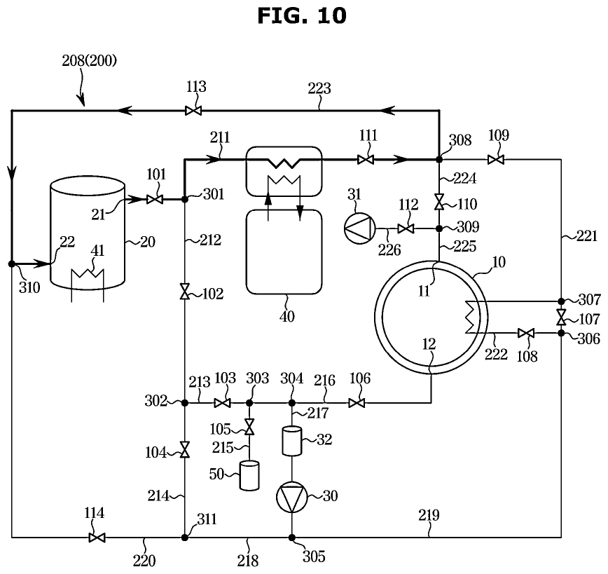

FIG. 10 is a conceptual diagram for describing a process of lowering the temperature and pressure inside a distillation tank in a washing machine according to an embodiment.

Hereinafter, a process of lowering the pressure and temperature inside the distillation tank 20 will be described with reference to FIG. 10.

During the above described process, the pressure and temperature inside the distillation tank 20 may rise to a level higher than a set value during the process of recovering the carbon dioxide in the washing tub 10 to the distillation tank 20. As described above with reference to FIG. 9, when carbon dioxide from the washing tub 10 continues to flow into the distillation tank 20 by passing through the pump 30, the pressure and temperature of the distillation tank 20 may increase together. When the process continues, the pressure inside the distillation tank 20 may increase excessively, which may cause stability concerns.

In order to control the temperature and pressure inside the distillation tank 20, the washing machine may include a second temperature sensor 72 provided to measure the temperature inside the distillation tank 20 and a second pressure sensor 74 provided to measure the pressure inside the distillation tank 20.

The controller 60 may lower the temperature inside the distillation tank 20 through a process described below based on temperature data received from the second temperature sensor 72. The controller 60 may lower the pressure inside the distillation tank 20 through a process described below based on the pressure data received from the second pressure sensor 74.

Referring to FIG. 10, the controller 60 may open the first valve 101, the eleventh valve 111, and the thirteenth valve 113. The controller 60 may close the second valve 102, the tenth valve 110, the ninth valve 109, and the fourteenth valve 114. The controller 60 may operate the chiller 40.

When the third opening 21 of the distillation tank 20 is opened and the first valve 101 is opened, carbon dioxide inside the distillation tank 20 may move to the first flow path connecting portion 301. At the first flow path connecting portion 301, in which the second valve 102 is closed and the eleventh valve 111 is opened, carbon dioxide may move along the first branch flow path 211, pass through the chiller 40 and move to the eighth flow connecting portion 308. Since carbon dioxide flowing inside the first branch flow path 211 passes through the chiller 40, the carbon dioxide inside the first branch flow path 211 may exchange heat with the chiller 40. The carbon dioxide may be cooled or liquefied by exchanging heat with the chiller 40.

The carbon dioxide moving to the eighth flow connecting portion 308 may move along the thirteenth flow path 223 to the tenth flow connecting portion 310 because the tenth valve 110 and the ninth valve 109 are closed and the thirteenth valve 113 is opened at the eighth flow path connecting portion 308. At the tenth connecting portion 310, in which the fourteenth valve 114 is closed, carbon dioxide may move into the distillation tank 20 through the fourth opening 22 of the distillation tank 20.

Through the above-described passage, carbon dioxide discharged from the distillation tank 20 may flow back into the distillation tank 20 through the chiller 40. By passing through the chiller 40, carbon dioxide is cooled and gaseous carbon dioxide is liquefied, and the carbon dioxide, having passed through the chiller 40, introduced into the distillation tank 20 may lower the temperature inside the distillation tank 20. In addition, the pressure inside the distillation tank 20 may be lowered.

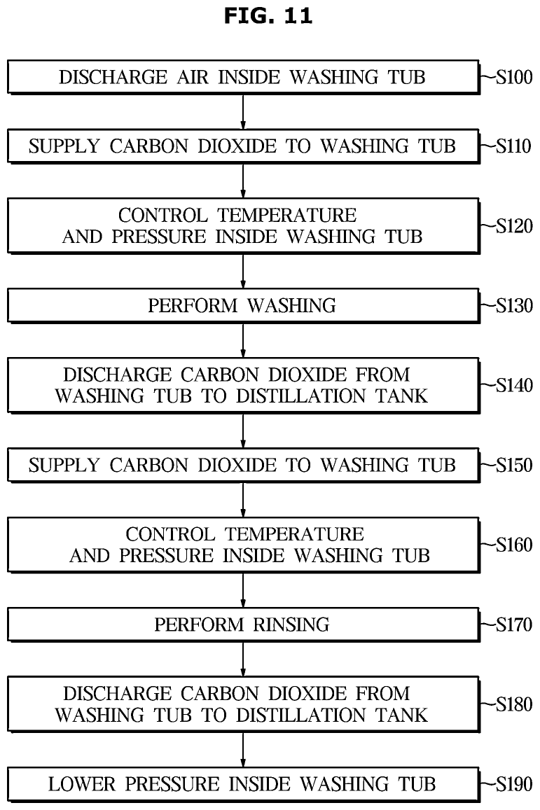

FIG. 11 illustrates a method of controlling a washing machine according to an embodiment.

Referring to FIG. 11, laundry is inserted into the drum in the washing tub 10, and the door of the washing tub 10 is closed, and then the air inside the washing tub 10 may be discharged (S100).

The controller 60 may operate the vacuum pump 31. As the vacuum pump 31 operates, the inside of the washing tub 10 may reach a low pressure close to a vacuum.

After discharging the air inside the washing tub 10, carbon dioxide may be supplied to the washing tub 10 (S110).

Since the inside of the washing tub 10 has a low pressure close to a vacuum by discharging the air inside the washing tub 10, gaseous carbon dioxide of the distillation tank 20 may be supplied to the washing tub 10 first. For example, the gaseous carbon dioxide may be supplied to the washing tub 10 through the process described above with reference to FIG. 3. In addition, the gaseous carbon dioxide may be supplied to the washing tub 10 through the process described above with reference to FIG. 5.

When the washing tub 10 is filling with the gaseous carbon dioxide and the pressure inside the washing tub 10 reaches a predetermined value or higher, liquid carbon dioxide may be supplied to the washing tub 10. For example, liquid carbon dioxide may be supplied to the washing tub 10 through the process above described with reference to FIG. 4.

When the carbon dioxide is supplied to the washing tub 10, the temperature and pressure inside the washing tub 10 may be controlled before performing the washing (S120).

The controller 60 may lower or raise the temperature and pressure inside the washing tub 10 based on the temperature data and pressure data received from the first temperature sensor 71 and the first pressure sensor 73. For example, the temperature and pressure inside the washing tub 10 may be lowered through the process described above with reference to FIG. 6, and the temperature and pressure inside the washing tub 10 may be raised through the process described above with reference to FIG. 7.

After controlling the temperature and pressure inside the washing tub 10, the washing may be performed (S130). When performing the washing, the drum may be rotated for several minutes.

After the washing cycle is completed, the carbon dioxide in the washing tub 10 may be discharged to the distillation tank 20 (S140).

For example, the carbon dioxide and foreign substances inside the washing tub 10 may be discharged to the distillation tank 20 through the process described above with reference to FIG. 8.

After discharging the carbon dioxide inside the washing tub 10, the carbon dioxide in the distillation tank 20 may be supplied back to the washing tub 10 (S150).

Since the inside of the washing tub 10 is already filled with gaseous carbon dioxide, the washing tub 10 may be supplied with liquid carbon dioxide.

Once carbon dioxide is supplied to the washing tub 10, the temperature and pressure inside the washing tub 10 may be controlled before performing the rinsing (S160)

The controller 60 may lower or raise the temperature and pressure inside the washing tub 10 based on the temperature data and pressure data received from the first temperature sensor 71 and the first pressure sensor 73.

After controlling the temperature and pressure inside the washing tub 10, the rinsing cycle may be performed (S170. According to an embodiment, the washing cycle and the rinsing cycle may each be performed a plurality of times.

When the rinsing is completed, the carbon dioxide in the washing tub 10 may be discharged to the distillation tank 20 (S180).

Before opening the washing tub 10, the pressure inside the washing tub 10 needs to be lowered to a level similar to the atmospheric pressure, and thus the inside of the washing tub 10 may be depressurized (S190).

For example, the pressure inside the washing tub 10 may be lowered through the process described above with reference to FIG. 9.

A washing machine according to an embodiment includes: a washing tub configured to wash laundry using carbon dioxide and having a first opening and a second opening; a distillation tank configured to accommodate carbon dioxide and foreign substances discharged from the washing tub, and in which the carbon dioxide is vaporized; a pump configured to move liquid carbon dioxide or gaseous carbon dioxide; a chiller disposed at one side of a flow path through which carbon dioxide flows, and configured to lower a temperature of the carbon dioxide flowing through the flow path; and a first flow path configured to connect the second opening, the pump, the chiller, and the first opening such that the carbon dioxide inside the washing tub passes through the pump and the chiller and returns to the washing tub.

The washing machine may further include a second flow path configured to connect the distillation tank, the pump, and the first opening of the washing tub such that the carbon dioxide inside the distillation tank is moved to the washing tub via the pump.

The washing machine may further include: a first valve configured to open and close the first flow path; a second valve configured to open and close the second flow path; and a controller configured to control the first valve and the second valve.

The controller may be configured to: control the first valve and the second valve to open the first flow path, to lower the temperature and the pressure inside the washing tub.

The controller may be configured to control the first valve and the second valve to open the second flow path, to raise the temperature and the pressure inside the washing tub.

The washing machine may further include: a third flow path configured to connect the distillation tank, the chiller, and the first opening of the washing tub.

The third flow path may be configured to branch from the second flow path at a point on the second flow path and merge the first flow path at a point on the first flow path.

The washing machine may further include a supplementary tank configured to supplement carbon dioxide to the washing tub.

The supplementary tank may be configured to connect an upstream side of the pump on the second flow path, to supply carbon dioxide to the washing tub through the second flow path.

The washing machine may further include a fourth flow path configured to connect the second opening of the washing tub, the pump, and the distillation tank.

The fourth flow path may be configured to branch off in one direction from a downstream side of the pump on the first flow path, connecting the downstream side of the pump and the distillation tank.

The washing machine may further include a fifth flow path configured to connect the second opening of the washing tub, the pump, the chiller, and the distillation tank,

The fifth flow path may be configured to branch off in an opposite direction from a downstream side of the pump on the first flow path, connecting the downstream side of the pump, the chiller, and the distillation tank.

The fifth flow path may further include a washing tub heat exchanger configured to pass through the washing tub.

The washing tub heat exchanger may be provided between the downstream side of the pump and the chiller.

The distillation tank may include a third opening and a fourth opening.

The fourth flow path may be configured to connect the downstream side of the pump to the fourth opening.

The fifth flow path may be configured to connect to the third opening via the chiller from the downstream side of the pump.

The washing machine may further include a sixth flow path configured to connect the third opening of the distillation tank, the chiller, and the fourth opening of the distillation tank.

The washing machine may further include a filter provided on an upstream side of the pump to prevent foreign substances larger than a predetermined size from flowing into the pump.

The washing machine may further include a heater disposed adjacent to the distillation tank to raise the temperature inside the distillation tank.

The washing machine may further include a first temperature sensor configured to measure a temperature inside the washing tub and a first pressure sensor configured to measure a pressure inside the washing tub.

The washing machine may further include a second temperature sensor configured to measure a temperature inside the distillation tank and a second pressure sensor configured to measure a pressure inside the distillation tank.

A method of controlling a washing machine including a washing tub, a distillation tank, a pump, and a chiller according to an embodiment includes: discharging air inside the washing tub, supplying carbon dioxide to the washing tub, controlling the temperature and pressure inside the washing tub, performing washing, discharging carbon dioxide in the washing tub to the distillation tank, supplying carbon dioxide to the washing tub, controlling the temperature and pressure inside the washing tub, performing rinsing, discharging carbon dioxide in the washing tub to the distillation tank, and depressurizing the inside of the washing tub.

When discharging air inside the washing tub and supplying carbon dioxide to the washing tub, gaseous carbon dioxide may be supplied first and then liquid carbon dioxide may be supplied.

When controlling the temperature and pressure inside the washing tub, the carbon dioxide inside the washing tub is allowed to pass through the pump and the chiller and then recovered into the washing tub such that the temperature and pressure inside the washing tub are lowered, and the carbon dioxide inside the washing tub is allowed to pass through the pump and then supplied to the washing tub such that the temperature and pressure inside the washing tub are raised.

When depressurizing the inside of the washing tub, the carbon dioxide discharged from the washing tub is allowed to pass through the pump, have heat exchanged with the carbon dioxide inside the washing tub, and the carbon dioxide heat-exchanged with the carbon dioxide inside the washing tub is allowed to pass through the chiller and then recovered in the distillation tank.

According to the disclosure, even in a washing machine having a two-tank structure that includes a washing tub 10 and a distillation tank 20 and does not include a separate carbon dioxide storage tank, the temperature and pressure inside the washing tub 10 can be controlled before the washing or rinsing cycle. With such a configuration, damage to the laundry can be prevented, and the stability of the washing tub 10, which is a pressure vessel, can be secured.

According to the disclosure, in the washing machine having a two-tank structure described above, the temperature and pressure inside the distillation tank (20) as well as the washing tub (10) can be controlled. With such a configuration, the stability of the distillation tank (20), which is a pressure vessel, can be secured.

While aspects of embodiments have been particularly shown and described, it will be understood that various changes in form and details may be made therein without departing from the spirit and scope of the following claims.

1. A washing machine comprising:
a washing tub having a first opening and a second opening;
a pump configured to move liquid carbon dioxide or gaseous carbon dioxide; and
a chiller,
wherein a first flow path connects the second opening, the pump, the chiller, and the first opening so that pumping by the pump moves carbon dioxide from inside the washing tub through the second opening along the first flow path to pass through the pump, then along the first flow path to pass through the chiller so as to be cooled by the chiller, and then along the first flow path to pass through the first opening to be returned to the washing tub.

2. The washing machine of claim 1, further comprising:
a distillation tank,
wherein a second flow path connects the distillation tank, the pump, and the first opening so that pumping by the pump moves carbon dioxide from inside the distillation tank along the second flow path to pass through the pump, then along the second flow path through the first opening to the washing tub.

3. The washing machine of claim 2, further comprising:
a first valve configured to open and close the first flow path;
a second valve configured to open and close the second flow path; and
a controller configured to:
control the first valve and the second valve to open the first flow path and close the second flow path so that pumping by the pump moves the carbon dioxide from inside the washing tub through the second opening along the first flow path at a first temperature and a first pressure to pass through the pump, then along the first flow path to pass through the chiller so as to be cooled by the chiller, and then along the first flow path to pass through the first opening to be returned to the washing tub at a second temperature lower than the first temperature and at a second pressure lower than the first pressure, and
control the first valve and the second valve to open the second flow path and close the first flow path so that pumping by the pump moves the carbon dioxide from inside the distillation tank along the second flow path at a third temperature and a third pressure to pass through the pump, then along the second flow path through the first opening to the washing tub at a fourth temperature higher than the third temperature and a fourth pressure higher than the third pressure.

4. The washing machine of claim 2, further comprising:
a heater configured to heat the distillation tank,
wherein a third flow path connects the distillation tank, the chiller, and the first opening so that heating by the heater moves the carbon dioxide from inside the distillation tank along the third flow path to pass through the chiller so as to be cooled by the chiller, and then along the third flow path to pass through the first opening to the washing tub, and
the third flow path branches from the second flow path at a point on the second flow path and merges with the first flow path at a point on the first flow path.

5. The washing machine of claim 2, further comprising:
a supplementary tank, wherein the supplementary tank connects to the second flow path at an upstream side of the pump so that pumping by the pump moves carbon dioxide from inside the supplementary tank along the second flow path through the pump, then along the second flow path to pass through the first opening to the washing tub.

6. The washing machine of claim 4, wherein
a fourth flow path connects the second opening, the pump, and the distillation tank so that pumping by the pump moves the carbon dioxide from inside the washing tub through the second opening along the fourth flow path to pass through the pump, then along the fourth flow path to the distillation tank, and
the fourth flow path branches from the first flow path at a downstream side of the pump.

7. The washing machine of claim 5, wherein
a fifth flow path connects the second opening, the pump, the chiller, and the distillation tank so that pumping by the pump moves the carbon dioxide from inside the washing tub through the second opening along the fifth flow path through the pump, then along the fifth flow path to pass through the chiller so as to be cooled by the chiller, and then along the fifth flow path to the distillation tank, and
the fifth flow path branches from the first flow path at a downstream side of the pump.

8. The washing machine of claim 7, further comprising:
a washing tub heat exchanger,
wherein the fifth flow path connects the second opening, the pump, the washing tub heat exchanger, and the distillation tank so that pumping by the pump moves the carbon dioxide from inside the washing tub through the second opening along the fifth flow path through the pump, then along the fifth flow path to pass through the washing tub heat exchanger so as to exchange heat with the carbon dioxide inside the washing tub, and then along the fifth flow path to the distillation tank.

9. The washing machine of claim 7, wherein
the distillation tank includes a third opening and a fourth opening, and
the fifth flow path connects the downstream side of the pump to the third opening via the chiller.

10. The washing machine of claim 6, wherein
the distillation tank includes a third opening and a fourth opening, and
the fourth flow path connects the downstream side of the pump to the fourth opening.

11. The washing machine of claim 9, wherein a sixth flow path connects the third opening, the chiller, and the fourth opening so that cooling by the chiller moves the carbon dioxide from inside the distillation tank through the third opening along the sixth flow path at a fifth temperature and a fifth pressure to pass through the chiller so as to be cooled by the chiller, and then along the sixth flow path to pass through the fourth opening to be returned to the distillation tank at a sixth temperature lower than the fifth temperature and a sixth pressure lower than the fifth pressure.

12. The washing machine of claim 1, further comprising a filter on an upstream side of the pump to prevent foreign substances larger than a predetermined size from flowing into the pump.

13. The washing machine of claim 4, wherein the heater is adjacent to the distillation tank and configured to raise a temperature inside the distillation tank.

14. The washing machine of claim 1, further comprising:
a first temperature sensor configured to measure a temperature inside the washing tub, and
a first pressure sensor configured to measure a pressure inside the washing tub.

15. The washing machine of claim 13, further comprising:
a second temperature sensor configured to measure the temperature inside the distillation tank, and
a second pressure sensor configured to measure a pressure inside the distillation tank.
